(19) United States
(12) Patent Application Publication
(10) Pub. No.: US 2022/0373029 A1
(43) Pub. Date: Nov. 24, 2022

(54) CERAMIC ROLLING ELEMENT WITH SKELETAL STRUCTURE

(71) Applicant: Schaeffler Technologies AG & Co. KG, Herzogenaurach (DE)

(72) Inventors: Perry Hollen, Fort Mill, SC (US); Jean-Francois Masbou, Fort Mill, SC (US)

(73) Assignee: Schaeffler Technologies AG & Co. KG, Herzogenaurach (DE)

(21) Appl. No.: 17/881,688

(22) Filed: Aug. 5, 2022

Related U.S. Application Data
(62) Division of application No. 17/158,297, filed on Jan. 26, 2021.
(60) Provisional application No. 62/969,938, filed on Feb. 4, 2020.

(51) Int. Cl. F16C 33/34

(52) U.S. Cl. CPC F16C 33/34; F16C 2206/40

(57) ABSTRACT

A bearing rolling element with a lattice internal structure provides several advantages over a solid bearing. It is lighter than a solid bearing, reducing centrifugal forces. For ceramic bearings, less material is required, and sintering times are reduced because bonding material can flow easily to near the surface. Elements with an internal lattice also offer advantages over hollow rolling elements. The shell can be thinner without sacrificing load capacity. The thinner shell reduces the time required for bonding material to be removed during sintering. The blank can be formed using various additive manufacturing processes.

### CROSS-REFERENCE TO RELATED APPLICATIONS

This application is a divisional of U.S. application Ser. No. 17/158,297 filed Jan. 26, 2021, which, in turn, claims priority to 62/969,938 filed Feb. 4, 2020, the entire disclosures of which are incorporated by reference herein.

### TECHNICAL FIELD

The disclosure concerns bearing rolling element structures. More particularly, the disclosure pertains to rolling bearings which have a lattice inner core.

### BACKGROUND

Bearings reduce the friction between components which are intended to move relative to one another, especially as force is transmitted from one of the components to the other. In rolling element bearings, a raceway is formed in each of the two components and a set of elements are contained within the raceways, separating the components. The contact between the elements and the raceways is predominantly rolling contact as opposed to sliding contact, thereby dramatically reducing the resistance to relative motion. In some applications, the rolling elements may be spaced relative to one another by a cage. Rolling elements may be balls, cylindrical rollers, tapered rollers, or spherical rollers.

Rolling elements may be made of metal, ceramics, or other materials depending on the application. In some applications, ceramic rolling elements offer advantages over their steel counterparts. The density, lower than steel for most ceramics (Silicon Nitride Si₃N₄ in particular), makes a very strong and light part allowing for good heat dissipation. It also offers electrical insulation properties valuable in some applications. The lower weight is also beneficial in high-speed applications by reducing centrifugal forces and improving system efficiency.

The main issues of the current solid ceramic rolling elements are the costs of the material and the length of time required to produce such a product. The typical manufacturing process includes making a blank by mixing a ceramic powder with bonding agents, then pressing the mixture into a die. The resulting blank can be either machined, prior to sintering, or sintered directly followed by several processing steps to reach final dimensions and surface finish. The bonding material is required in order for the ceramic particles to hold their shape after removal from the die. Although the bonding material is required to make the rolling element, it must be removed during the hardening process to produce a pure ceramic product with the highest possible levels of particulate density. Extreme heat is required to burn off the bonding materials during the ceramic hardening. Larger rolling elements require longer processing times with more potential for distortion from shrinkage.

The downside of the above-described process is high cost due to expensive material (up to 70% of total cost) and multiple, very long processing steps (typically between 150 and 500 hours). This high cost limits the applications of these products to niche fields where heat or speed are critical factors. Furthermore, as blanks are produced in a die, tooling cost and delivery are important factors dramatically increasing the cost-effectiveness for low-volume applications.

### SUMMARY

A rolling element for a bearing includes a continuous outer shell and a lattice structured core within the outer shell. The shell and the core may be made of a ceramic. The shell may have a spherical outer surface. The core may be bonded to an inner surface of the outer shell, for example, by being integrally formed with the outer shell.

A method of producing a rolling element for a bearing includes forming a hollow rolling element blank including ceramic and a bonding material by an additive manufacturing process; and evacuating the bonding material from the hollow rolling element blank.

### BRIEF DESCRIPTION OF THE DRAWINGS

FIG. 1 is a cut-away view of a hollow ball rolling element.

FIG. 2 is a cut-away view of a partially hollow ball rolling element with a lattice core.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

Use of hollow or partially hollow rolling elements offers advantages in many applications regardless of material and geometric configurations.

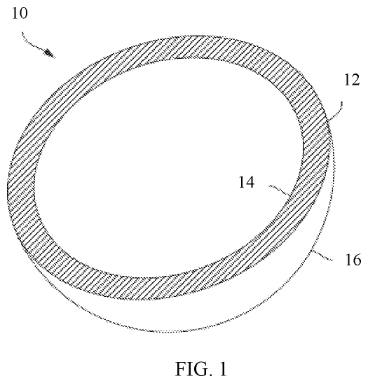

FIG. 1 is a cut-away view illustrating a hollow ball rolling element 10. Rolling elements other than balls may also be hollow. The ball includes a shell 12 with an inner spherical surface 14 and an outer spherical surface 16. The shell must be sufficiently thick to carry the design load. Hollow ceramic rolling elements are particularly advantageous. For a given rolling element diameter, a hollow rolling element uses substantially less material, reducing both cost and mass. Furthermore, evacuating the bonding materials from the shell requires substantially less time than removing them from the core of a solid element.

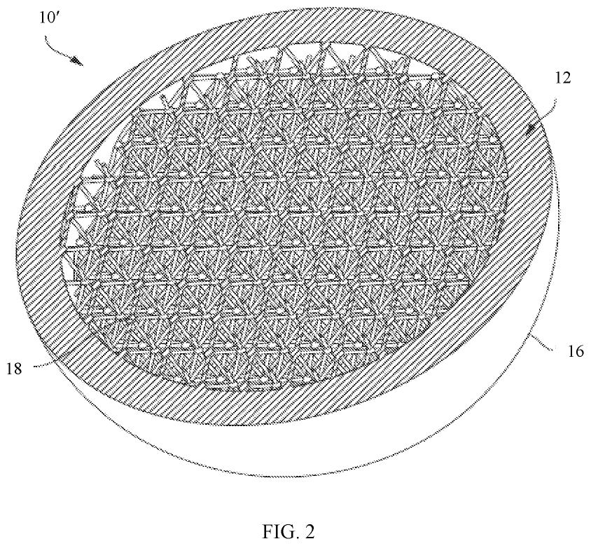

FIG. 2 is a cut-away view illustrating a partially hollow ball rolling element 10′ with a skeletal core 18. The skeletal framework provides extra strength, increasing the load capacity or decreasing the required shell thickness for a given design load. The open space in the lattice permits the bonding material from the lattice material to move easily to the inner surface of the shell during the sintering process, such that sintering times are substantially reduced relative to a solid.

Conventional molding processes are unsuitable for fabricating the blanks for the balls of FIGS. 1 and 2. However, additive manufacturing processes (sometimes called 3D printing) are capable of producing these blanks.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A method of producing a rolling element for a bearing comprising:
forming a hollow rolling element blank comprising ceramic and a bonding material by an additive manufacturing process; and
evacuating the bonding material from the hollow rolling element blank.

2. The method of claim 1 wherein a thickness of the hollow rolling element blank is selected to carry a design load.

3. The method of claim 1 wherein the hollow rolling element blank comprises:
an outer shell;
an inner shell; and
a thickness between the inner shell and the outer shell selected to carry a design load.

4. The method of claim 3 wherein the hollow rolling element blank further comprises a skeletal core.

5. The method of claim 3 wherein the outer shell and the inner shell are spherical.

6. The method of claim 5 wherein the hollow rolling element blank further comprises a skeletal core.

7. The method of claim 1 wherein the evacuating the bonding material comprises a sintering process.
